(19) United States
(12) Patent Application Publication
(10) Pub. No.: US 2014/0152635 A1
(43) Pub. Date: Jun. 5, 2014

(54) SYSTEMS AND METHODS FOR POWERING DISPLAY BOARDS

(71) Applicant: LSI INDUSTRIES, INC., Cincinnati, OH (US)

(72) Inventor: Marc Morrisseau, Quebec (CA)

(73) Assignee: LSI Industries, Inc., Cincinnati, OH (US)

(21) Appl. No.: 13/692,491

(22) Filed: Dec. 3, 2012

Related U.S. Application Data
(60) Provisional application No. 61/732,329, filed on Dec. 1, 2012.
(60) Provisional application No. 61/732,330, filed on Dec. 1, 2012.

(51) Int. Cl. G09G 3/32

(52) U.S. Cl. CPC G09G 3/3208
USPC 345/211; 345/82

(57) ABSTRACT

Systems and methods are described for providing data to the multiple LED blocks of a LED display board. Each LED block can include an electrical connection or interface that has a reduced complexity compared with prior LED display boards. Six pins may be used for the connections between blocks—including a ground pin, an input/output (I/O) pin, two video link pins, and two communication link pins. Systems and methods are described for controlling the power supplied to LED block(s) of a LED display board. A power controller coordinates the supply of power to the LED blocks. The power controller controls the supply of power to selected groups of the blocks of a video board in a way to reduce the differences in peak instantaneous power supplied to sections of the display board or the entire display board itself, and thereby increase the useful service life of the power supply components.

### CROSS REFERENCE TO RELATED APPLICATIONS

The present disclosure claims priority to U.S. Provisional Application No. 61/732,329, filed on Dec. 1, 2012, and entitled “Systems and Methods for Display Board Control,” and to U.S. Provisional Patent Application No. 61/732,330, filed on Dec. 1, 2012, and entitled, “Systems and Methods for Powering Display Boards”; the entire content of both of which are incorporated by reference herein. The present disclosure is related to U.S. application Ser. No. 13/691,787 filed on Dec. 1, 2012, and entitled “Display Boards and Display Board Components,” and is also related to U.S. application Ser. No. ______ filed herewith and entitled “Systems and Methods for Display Board Control”; the entire content of both of which are incorporated by reference herein.

### FIELD OF THE INVENTION

The subject technology relates generally to video technology. More specifically, the subject technology relates to control and powering of display boards.

### BACKGROUND OF THE INVENTION

Large scale display boards have gained prominence as devices for displaying images, both still and moving, in various applications such as in advertising and stadium-based sporting events. Light-emitting diodes (LEDs) are often used as the light sources for such boards, in which case the boards may be referred to as LED display boards or LED display boards. LED based display boards may be used to display images, for example, at stadiums and arenas, as billboards along highways and other roads, and at convention centers, among other numerous and varied locations.

Because of the relatively large scales used for some applications, notably as displays at arena sporting events and as billboards along highways, LED video boards are often complex systems with structures that have many modules or blocks, each including an array of many LEDs. To provide for coordinated power delivery and lighting control of all of the LEDs of all of the blocks. LED video boards typically utilize many (e.g., thousands) of power and communications connections, between all of the modules. As a result, the LED video boards have proven to be difficult and expensive to repair and maintain.

The size and complexity of the electrical links in such connections contribute to the difficulty and expense of conducting repair and maintenance for LED video boards. For example, for the connections between its individual blocks, a prior art LED board may have utilized a relatively large number of connection pins (e.g., 110) at each module. For each block failing or malfunctioning in such an LED board, the large number of pins would often require that a service technician spend a significant amount of time ascertaining which one or more pins, if any, were faulty. Such a service event represent a significant expense for a single block in a LED video board, let alone the many blocks that often fail.

In addition to the problems with connections between blocks, the power supplies used for such LED videos boards have been recognized as a common point of failures. Because of the frequent on-off cycling of current demands, due to the large changes in the instantaneous power provided to the LED video boards for display of video content, the power supply circuit(s) often fail, exhibiting a relatively short life service life.

### SUMMARY OF THE INVENTION

The present disclosure is directed to and describes display boards and display board components, as well as related systems and methods, that overcome deficiencies in prior lighting apparatuses. A display board as described herein can be capable of displaying still images and/or video. Use of the terms “video,” “display,” “image” or the like herein is not intended to limit the scope of the disclosure to a board, or components thereof, capable of displaying only still images, only video, or both still images and video. Thus, while various elements of the preferred embodiment(s) may have the term “video” in their name, that er does not preclude use of that embodiment or element with still images.

According to some aspects, the subject technology is directed to systems for providing data, e.g., video data, to the multiple LED blocks of a LED display board. The systems can include a master controller for multiple LED blocks arranged according to an order (e.g., in a matrix); accordingly, the master controller may be referred to as a “matrix controller.” Each LED block can include an electrical connection or interface that has a reduced complexity compared with prior LED display boards. For example, in exemplary embodiments, six pins may be used for the connections between blocks—the six pins including a ground pin, an input/output (I/O) pin, two video link pins for receiving video data, and two communication link pins for communications data. The matrix controller is connected, via a multicast connection, to the video data including lighting control commands (or, “output settings”) for the LEDs in the multiple LED blocks. The LED blocks that receive the appropriate signal on an I/O pin, e.g., a “1,” process the broadcast video data including the output settings, while the remaining LED blocks forego processing the output settings. That particular LED block then controls its LEDs according to those received and processed output settings. The matrix controller provides, via the multicast connection, instructions for each LED block previously having received a I/O pin previously set to 1 to set its I/O pin to 1. Thus, when the next output settings are sent, the next LED block in the order will have its I/O pin set to 1 and its I/O pin set to 0, and will thus process the next output settings.

According to some aspects, the subject technology is directed to systems and methods for controlling the power supplied to LED block(s) of a LED display board. A power controller may be used to coordinate the supply of power to the LED blocks. Such a power controller may be implemented in hardware, firmware, and/or software, which may be composed of or include computer-readable instructions (e.g., code) stored in a computer-readable medium or media. The power controller controls the supply of power to selected groups of the blocks of a video board in a way to reduce the differences in peak instantaneous power supplied to sections of the display board or the entire display board itself, and thereby increase the useful service life of the attendant power supply components.

For this controlled power distribution, the power controller causes sections of the LED display board to be powered on (e.g., to implement the lighting control commands or “output settings” referred to above) at slightly different times. This staged activation among the sections of blocks is performed within a time period that is designed and selected so as to not be discernable by viewing audiences. As an example, for such a power sharing scheme, a LED display board having 600 blocks (each having a number of LEDs arranged in an array) may have its blocks segregated into four (4) groups of 150 blocks each. A power controller can cause a first group of 150 blocks to power on, for implementing desired output settings (e.g., RGB values all set to 50% intensity), and to stay on for a desired length of time, e.g., according to a first periodic step function. After a designated waiting time, the power controller causes a second group of the blocks to be powered on. Likewise, after another designated waiting time, the third group of blocks is turned on, and then after another waiting period, the fourth group of blocks. Preferably, the waiting periods are selected so that no visual differences among the groups of blocks due to power delivery are discernable. For the example given previously, with four groups of blocks and using the frame rate (e.g., 24 frames per second) of motion pictures as a guide, the overall time over which all of the four groups of blocks should be turned on would be 1/24 s, which is approximately 40 milliseconds. Within this 40 milliseconds (after the first group of blocks is turned on), the power controller causes activation of the three remaining groups after three successive and equal waiting periods of (40/3) ms, or 13.33 ms each. By activating the four groups of blocks in such a manner, the instantaneous peak changes in power supplied to the LED display board as a whole is reduced by a factor of four (4), which can increase longevity of the power supply components and decrease repair costs.

### BRIEF DESCRIPTION OF THE DRAWINGS

The present disclosure will be understood more readily from the following detailed description of the invention, when taken in conjunction with the accompanying drawings, in which:

FIG. 1 illustrates an exemplary system for LED video board control.

FIGS. 2A-2B illustrate exemplary LED blocks of FIG. 1.

FIG. 3 illustrates an exemplary data structure that may be transmitted via the connection of FIG. 1.

FIG. 4 illustrates an exemplary process for providing instructions to LED blocks.

FIG. 5 illustrates an exemplary computing device for managing power supply load of light-emitting diode blocks.

FIG. 6 illustrates an exemplary process for managing power supply for LED blocks.

FIGS. 7A-7B illustrate exemplary graphs of power supply load with respect to time.

FIG. 8 conceptually illustrates an exemplary electronic system for exemplary implementations of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. It is to be understood that the disclosure is intended in an illustrative rather than in a limiting sense, as it is contemplated that modifications will be apparent to those skilled in the art, within the spirit of the invention and the scope of the appended claims. Like components are labeled with identical reference numbers for ease of understanding.

The subject technology is directed to and provides control and powering of display boards, including LED display boards, which because of usefulness in displaying video images, may be referred to herein as “video boards.”

According to some aspects, the subject technology is directed to systems for providing data, e.g., video data, to the multiple LED blocks of a LED display board. The systems can include a master controller for multiple LED blocks arranged according to an order (e.g., in a matrix); accordingly, the master controller may be referred to as a “matrix controller.” Each LED block can include an electrical connection or interface that has a reduced complexity compared with prior LED display boards. For example, in exemplary embodiments, six pins may be used for the connections between blocks—the six pins including a ground pin, an input/output (I/O) pin, two video link pins for receiving video data, and two communication link pins for communications data. The matrix controller is connected, via a multicast connection, to the multiple LED blocks.

The I/O pin for each LED block can be connected to the I/O pin for the immediately adjacent LED blocks (i.e., adjacent in terms of an order designated for the blocks of the LED board). For example, the I/O pin for LED block #2 (in an order designated for a particular LED board) can be connected to the I/O pin for each of LED block #1 and LED block #3. In addition, the matrix controller includes an I/O pin that can connect to and provide/receive data to/from the I/O pin of the first LED block in the designated block order. Each I/O pin is operative to be set to a desired value, e.g., either 0 or 1, and may be used for handshaking or a way to pass tokens between blocks. In some aspects, the I/O pin for LED block #2 receives output from the matrix controller or from LED block #2 and provides input to LED block #3.

For the control of the video data that the individual blocks receive and consequently display, the matrix controller initiates a handshaking or token passing process. For this, the matrix controller provides, via the multicast connection, instructions to the multiple LED blocks to set their I/O pin to a desired value, e.g., 0. The matrix controller also sets the output value on its own I/O pin (which is connected to the I/O pin for the first LED block in the order) to a desired value (e.g., 1) different from the instructions sent by broadcast to the multiple LED blocks. The controller provides, via the multicast connection, video data including lighting control commands (or, “output settings”) for the LEDs in the multiple LED blocks. The LED blocks that receive the appropriate signal on an I/O pin, e.g., a “1,” process the broadcast video data including the output settings, while the remaining LED blocks forego processing the output settings. That particular LED block then controls its LEDs according to those received and processed output settings. The matrix controller provides, via the multicast connection, instructions for each LED block previously having received a I/O pin previously set to 1 to set its I/O pin to 1. Thus, when the next output settings are sent, the next LED block in the order will have its I/O pin set to 1 and its I/O pin set to 0, and will thus process the next output settings.

According to some aspects, the subject technology is directed to systems and methods for controlling the power supplied to LED block(s) of a LED display board. A power controller may be used to coordinate the supply of power to the LED blocks. Such a power controller may be implemented in hardware, firmware, and/or software, which may be composed of or include computer-readable instructions (e.g., code) stored in a computer-readable medium or media. The power controller controls the supply of power to selected groups of the blocks of a video board in a way to reduce the differences in peak instantaneous power supplied to sections of the display board or the entire display board itself, and thereby increase the useful service life of the attendant power supply components.

For this controlled power distribution, the power controller causes sections of the LED display board to be powered on (e.g., to implement the lighting control commands or “output settings” referred to above) at slightly different times. This staged activation among the sections of blocks is performed within a time period that is designed and selected so as to not be discernable by viewing audiences. As an example, for such a power sharing scheme, a LED display board having 600 blocks (each having a number of LEDs arranged in an array) may have its blocks segregated into four (4) groups of 150 blocks each. A power controller can cause a first group of 150 blocks to power on, for implementing desired output settings (e.g., RGB values all set to 50% intensity), and to stay on for a desired length of time, e.g., according to a first periodic step function. After a designated waiting time, the power controller causes a second group of the blocks to be powered on. Likewise, after another designated waiting time, the third group of blocks is turned on, and then after another waiting period, the fourth group of blocks. Preferably, the waiting periods are selected so that no visual differences among the groups of blocks due to power delivery are discernable. For the example given previously, with four groups of blocks and using the frame rate (e.g., 24 frames per second) of motion pictures as a guide, the overall time over which all of the four groups of blocks should be turned on would be 1/24 s, which is approximately 40 milliseconds. Within this 40 milliseconds (after the first group of blocks is turned on), the power controller causes activation of the three remaining groups after three successive and equal waiting periods of (40/3) ms, or 13.33 ms each. By activating the four groups of blocks in such a manner, the instantaneous peak changes in power supplied to the LED display board as a whole is reduced by a factor of four (4), which can increase longevity of the power supply components and decrease repair costs.

Aspects of the subject technology are described herein in terms of discrete values or states, e.g., the values 0 and 1 for logical conditions of FALSE and TRUE. It should be noted that such discrete values or states can be represented by discrete signals such as voltages and/or currents measured, obtained, or provided by electrical and/or electronic circuitry, including integrated circuit components. Of course, the preceding are offered by way of example and in some cases, other discrete values, e.g., ones opposite to those given. For example, 0 could represent a switch being turned off and 1 could represent the switch being turned on, or vice versa. In some aspects, any first value may replace 0 and any second value may replace 1. For example, to reduce the possibility of error, three or four bits, rather than a single bit, can be used to represent Boolean values of 1 and 0.

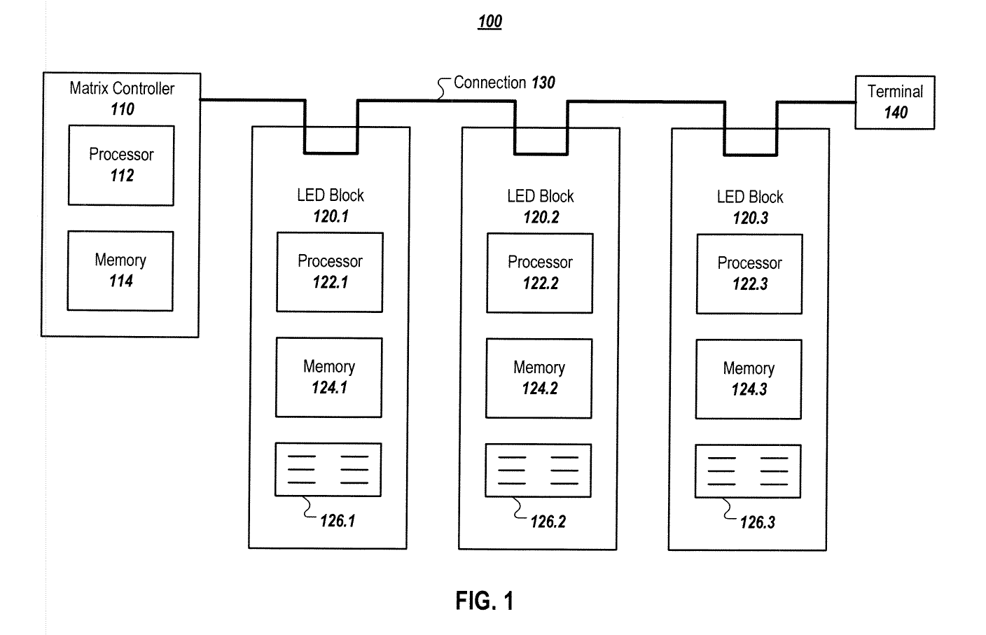

FIG. 1 illustrates an exemplary system 100 for LED video board control. As shown, the system 100 can include a matrix controller 110 connected to LED blocks 120.1-3 via a connection 130 that terminates at a terminal node 140.

In some aspects, the connection 130 is a multicast or broadcast connection that allows the matrix controller 110 to transmit data or instructions to each and every LED block 120.1-3. The connection 130 can be implemented using wire(s) or cable(s) in suitable parallel and/or serial connections.

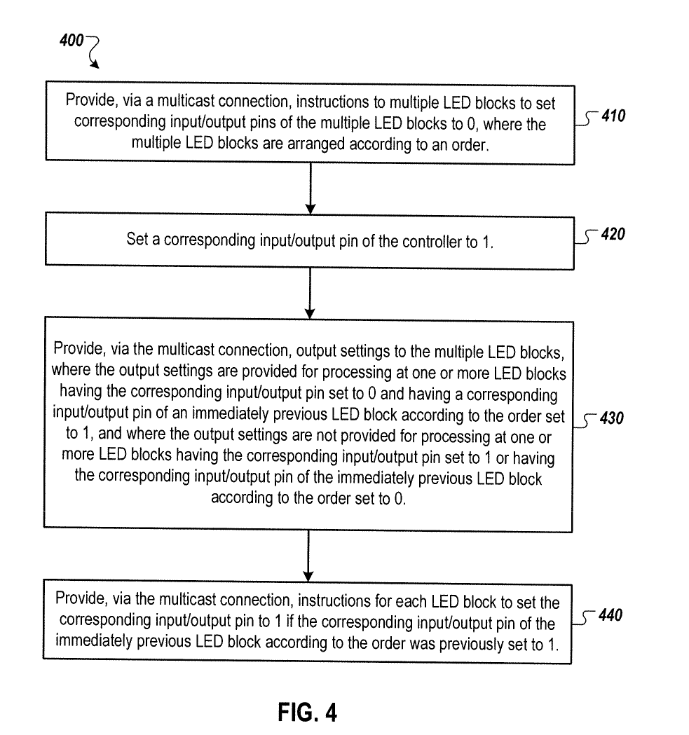

As shown, the matrix controller 110 includes a processor 112 and a memory 114. While a single processor 112 is illustrated, the matrix controller 110 may have any number of processors or any processing hardware, for example, a central processing unit (CPU), a graphics processing unit (GPU) or a control block. The memory 114 may be one or more of a cache unit, a storage unit, an internal memory unit, or an external memory unit. The memory 114 includes code that the processor 112 is operative to execute. The code can be written in software. Alternatively, the processor 112 can include hardware that execute the code. The code can include instructions for implementing the process described below in conjunction with FIG. 4.

While three LED blocks 120.1-3 are illustrated, the subject technology can be implemented with any number of LED blocks. Each LED block 120.k includes a processor 122.k, a memory 124.k, and LED light source(s) 126.k. While a single processor 122.k is illustrated, each LED block 120.k may have any number of processors or any processing hardware, for example, a central processing unit (CPU), a graphics processing unit (GPU) or a control block. The memory 124.k may be one or more of a cache unit, a storage unit, an internal memory unit, or an external memory unit. The memory 124.k includes code that the processor 122.k is operative to execute. The code can be written in software. Alternatively, the processor 122.k can include hardware that execute the code. In some aspects, the code includes providing for processing of received communication settings or received video settings if a signal received on an I/O pin of the LED block 120.k (e.g., which may be one pin in a 6-pin connection or interface resident on or connected to the LED block 120.k) is set to a designated value, e.g., 1 and foregoing processing of the received communication settings or the received video settings if a signal received on an I/O pin is set to another designated value, e.g., 0. In some aspects, the LED blocks 120.1-3 are arranged according to an order, where an I/O pin of one LED block in the order serves as an I/O pin for the immediately next LED block in the order. The LED light source(s) 126.k can be any known LED light source(s), for example, LED bulbs.

The terminal 140 indicates an end point of the data connection.

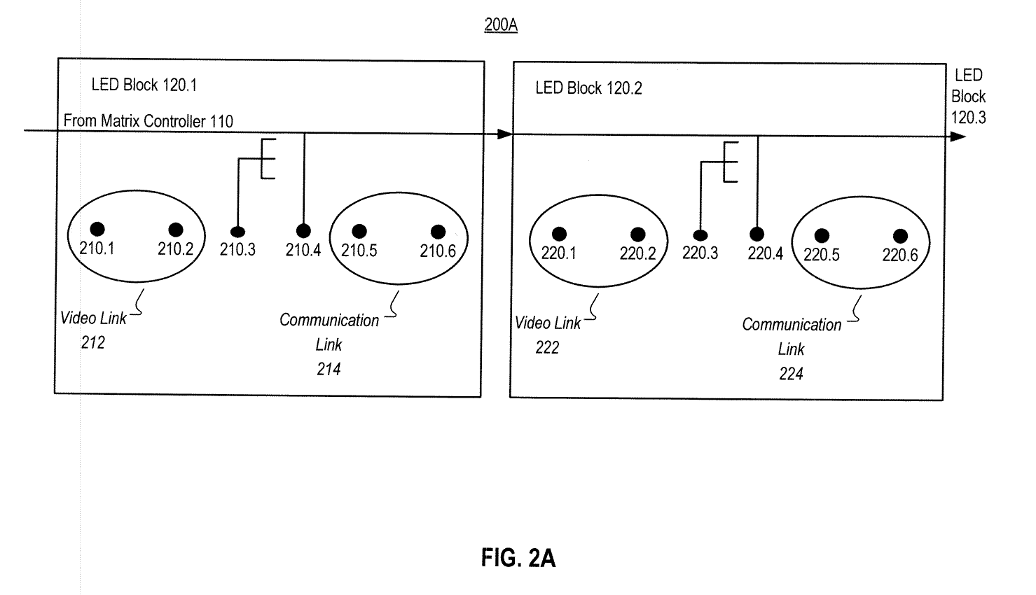

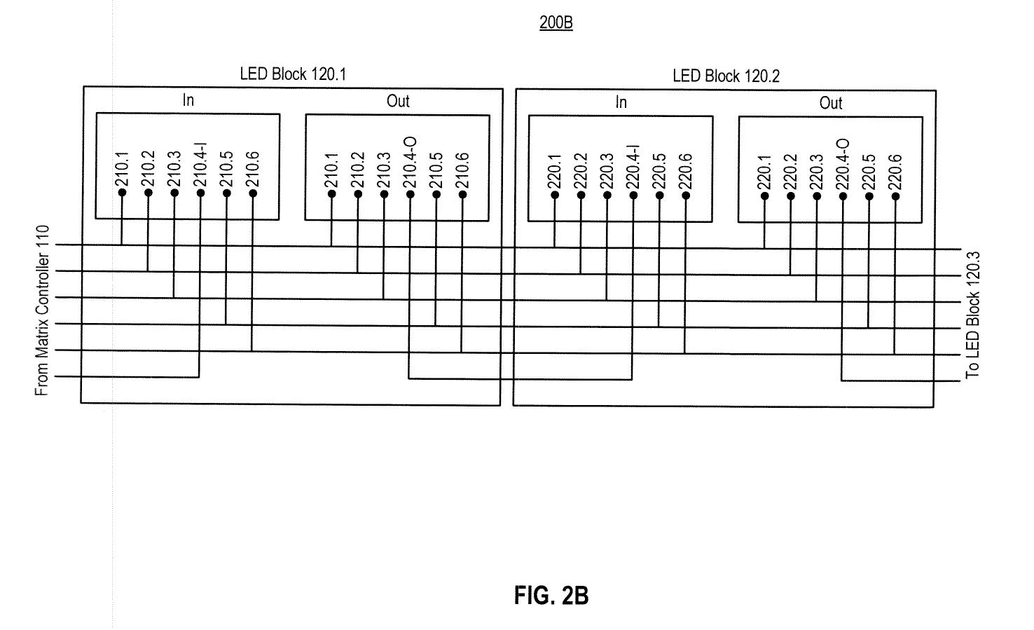

As was noted previously, aspects of the subject technology can provide for connections between LED blocks that utilize reduced pin counts relative to previous LED display boards. FIGS. 2A-2B illustrate exemplary light-emitting diode blocks of FIG. 1 utilizing connections with only six pins. The LED blocks 120.1-3 in the system 200A and 200B of FIGS. 2A-2B correspond to the LED blocks 120.1-3 in the system 100 of FIG. 1. Of course, while six pins are depicted for the exemplary embodiments in the drawings, other numbers of pins may be utilized for connections between LED blocks. For example, some embodiments may utilize four pins, five, seven, eight, nine, or ten pins, etc.

As shown in FIG. 2A, each LED block 120.k includes an interface or connection with six pins. For example, LED block 120.1 includes six pins 210.1-6. The video link 212 includes pins 210.1-2, which are video link pins for receiving video data (e.g., from the matrix controller 110). The communication link 214 includes pins 210.5-6, which are communication link pins for receiving communication data (e.g., from the matrix controller 110). Pin 210.3 is a ground pin operative to establish the ground charge. Pin 210.4 is the I/O pin for LED block 120.1. LED block 120.k receive instructions to initially set or produce an output signal on I/O pin 210.4 of a first designated value, e.g., 0, and subsequent instructions to set or produce an output signal on I/O pin 210.4 of a second designated value, e.g., 1, after output data is received (e.g., from the matrix controller 110). As shown, pin 210.4 is connected to LED block 120.2, as pin 210.4 serves as the I/O pin for LED block 120.2. According to some aspects, LED block 120.1 is the first LED block in an order of LED blocks, and the I/O pin for LED block 120.1 resides on the matrix controller 110.

The pins 220.1-6 of LED block 120.2 function similarly to the pins 210.1-6 of LED block 120.1. The video link 222 includes pins 220.1-2, which are video link pins for receiving video data (e.g., from the matrix controller 110). The communication link 224 includes pins 220.5-6, which are communication link pins for receiving communication data (e.g., from the matrix controller 110). Pin 220.3 is a ground pin operative to establish the ground charge. Pin 220.4 is the I/O pin for LED block 120.2, which may be initially set to 0, and is set to 1 after output data is received (e.g., from the matrix controller 110). As shown, pin 220.4 is connected to LED block 120.3, as pin 220.4 serves as the I/O pin for LED block 120.3. The I/O pin for LED block 120.1 is pin 210.4, which resides on LED block 120.1 and is the I/O pin for LED block 120.1.

In FIG. 2A, the input connections (6 pin) and output connections (6 pin) are represented by the same connection. In FIG. 2B, the input and output connections are shown separately, i.e., I/O pin 210.4 in FIG. 2A is split into input pin 210.4-I and output pin 210.4-0 in FIG. 2B, I/O pin 220.4 in FIG. 2A is similarly split into input pin 220.4-I and output pin 220.4-0 in FIG. 2B. Of course, where shown are described herein as being co-located or the same connection, it will understood that the input and output connections for a LED block can be separate, e.g., as shown in FIG. 2B.

According to the aspects of the subject technology illustrated in FIGS. 2A-2B, LED block 120.1 may be a first LED block according to the order of LED blocks. In the order, LED block 120.1 is immediately followed by LED block 120.2, which is immediately followed by LED block 120.3.

According to some aspects, the I/O pins 210.4 and 220.4 are connected to the matrix controller 110 via a suitable connection such that handshaking or token passing can occur from the matrix controller 110 to LED block 120.1 and then to LED block 120.2. The connection of pin 210.4 with the matrix controller 110 is in series with the connection of pin 220.4 with the matrix controller 110. This series connection can facilitate the handshaking or token passing between the LED block—allowing each one in turn to be told when (by the passing of the token to receive the broadcast video display setting and use those settings for itself; at other times, the particular block will ignore the broadcast video settings, which are coming to the LED blocks over the video lines in a serial protocol in accordance with the present disclosure.

According to some aspects, the communication links 214 and 224 and their pins 210.5-6 and 220.5-6, respectively, can be connected to the matrix controller 110 via a connection (e.g., connection 130). The connection of the communication link 214 of LED block 120.1 with the matrix controller 110 is in parallel with the connection of the communication link 224 of LED block 120.2 with the matrix controller 110. Any suitable communication protocol can be used for communication between the matrix controller 110 and the LED blocks 120.1-2, e.g., NRZ, NRZi, Aurora 8B/10B, SMPTE, etc.

According to some aspects, the video links 212 and 222 and their pins 210.1-2 and 220.1-2, respectively, can be connected to the matrix controller 110 via a connection (e.g., connection 130). The connection of the video link 212 of LED block 120.1 with the matrix controller 110 is in parallel with the connection of the video link 222 of LED block 120.2 with the matrix controller 110.

The video links 212 and 222 and the communication links 222 and 224 are operative to receive output settings (e.g., video or communication settings) from the matrix controller 110 at the LED blocks 120.1 and 120.2.

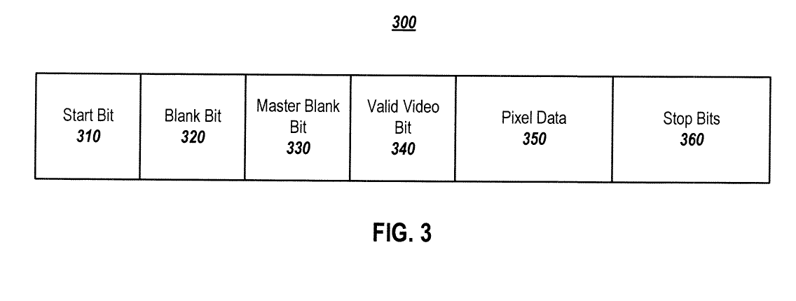

FIG. 3 illustrates an exemplary data structure 300 that may be transmitted via the connection of FIG. 1. It should be noted that other data structures may also be transmitted using the subject technology, e.g., the system 100 of FIG. 1 or others within the scope of the present disclosure.

As shown, the data structure includes a start bit 310, a blank bit 320, a master blank bit 330, a valid video bit 340, pixel data 350, and stop bits 360.

The start bit 310 indicates the beginning of the data structure 300. As shown, the start bit 310 is a single bit. However, in some aspects multiple bits can be used to indicate the beginning of the data structure 300.

The blank bit 320 can be utilized as a switching signal (e.g., a transistor signal). The master blank (mblank) bit 330 is used to indicate that the data structure is synchronized and that the next frame is about to begin. The blank bit 320 and the master blank bit 330 are used to synchronize the video link through all of the LED blocks (e.g., LED blocks 120.1-3) and to synchronize the signal across the LED blocks. As shown, each of the blank bit 320 and the master blank bit 330 is a single bit. However, in some aspects, either the blank bit 320 or the master blank bit 330 may include multiple bits.

The valid video bit 340 is used to indicate that valid video data is being transmitted in the data structure 300 to allow the video data to pass through the electronic circuitry. As shown, the valid video bit 340 is included in the data structure 300 as a single bit. However, in some aspects, the data structure 300 may not include a valid video bit 340, or the valid video bit 340 may include multiple bits.

The pixel data 350 includes data for one or more pixels and may include 48 bits per pixel or between 40 and 56 bits per pixel. As illustrated in FIG. 3, pixel data 350 is transmitted in the data structure 300. However, in some aspects, data other than pixel data may be transmitted using the techniques described herein, for example, the system 100 of FIG. 1.

The stop bits 360 indicate the termination of the data structure 300. In some aspects the stop bits 360 may include 12 bits or 4-20 bits. In some aspects, the stop bits 360 may include any number of bits or a single stop bit. Of course, while certain numbers of bits are provided herein by way of example, other suitable numbers of bits may be used.

FIG. 4 illustrates an exemplary process 400 for providing instructions to light-emitting diode blocks.

The process 400 begins at step 410, where a controller (e.g., matrix controller 110) provides, via a multicast connection (e.g., connection 130), instructions to multiple LED blocks (e.g., LED blocks 120.1-3) to set corresponding I/O pins (e.g., pins 210.4 and 220.4) of the multiple LED blocks to a first value, e.g., 0. The multiple LED blocks are arranged according to an order. The order corresponds to an order in which output settings are provided for processing at the multiple LED blocks. Each I/O pin resides on a specified LED block and serves as the I/O pin for the specified LED block and the I/O pin for the immediately next LED block in the order. The controller also includes a corresponding I/O pin, which serves as the I/O pin of the first LED block according to the order. Alternatively, the controller can be connected to the I/O pin of the first LED block via a unicast connection.

The multicast connection can include a video link. The video link can include exactly two pins at each LED block; the use of two pins can facilitate the use of differential signaling, which can overcome or mitigate problems due to noise or other interference The multicast connection can include a communication link. The communication link can include exactly two pins at each LED block; the use of two pins can facilitate the use of differential signaling. In other embodiments of the various aspects of the subject technology, a single pin can be used for the video link and/or the communication link, thus enabling a 4-pin or 5-pin connection or interface between LED display blocks.

In step 420, the controller sets the corresponding I/O pin of the controller, which also serves as the input bit for the first LED block according to the order, to a second value, e.g., 1.

In step 430, the controller provides, via the multicast connection, output settings (e.g., video or communication settings) to the multiple LED blocks. The output setting are provided for processing at the one or more LED blocks having the corresponding I/O pin (the I/O pin of the LED block) set to the first value, e.g., 0, and the corresponding I/O pin (the I/O pin of the immediately previous LED block according to the order) set to the second value, e.g., 1. The output settings are not provided for processing at one or more LED blocks having the corresponding I/O pin set to the second value, e.g., 1, or having the corresponding I/O pin set to the first value, e.g., 0.

In step 440, the controller provides, via the multicast connection, instructions for each LED block to set the corresponding I/O pin of the LED block to the second value, e.g., 1, if the corresponding I/O pin of the LED block was previously set to the second value, e.g., 1. After step 440, the process 400 ends.

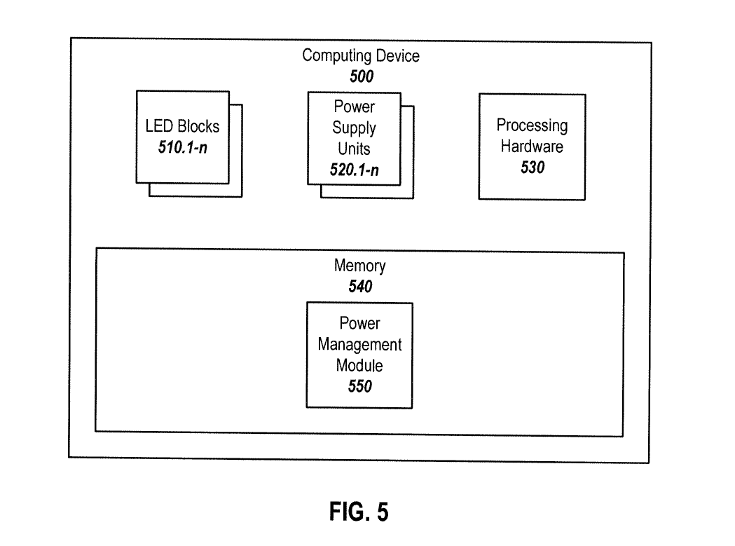

FIG. 5 illustrates an exemplary computing device 500 for managing power supply load of light-emitting diode blocks.

As shown, the computing device 500 includes LED blocks 510.1-n, power supply units 520.1-n, processing hardware 530, and a memory 540. The LED blocks 510.1-n are LED units operative to display image(s). The LED blocks 510.1-n can correspond to the LED blocks 120.1-3. The subject technology can be implemented with any number of LED blocks 510.1-n, for example, one, two, three, four, five, or more than five LED blocks 510.1-n. The power supply units 520.1-n can correspond to any power supply, for example, a battery or a wall plug. Each LED block 510.k can correspond to its own power supply unit 520.k, as described, for example, in the patent application titled “Video Board and Video Board Components,” and filed in the United States Patent & Trademark Office herewith. Alternatively, multiple LED blocks 510.k₁-k₂ can correspond to a single power supply unit 520.k, multiple power supply units 520.k₁-k₂ can provide power to a single LED block 510.k, or multiple power supply units 520.k₁-k₂ can provide power to multiple LED blocks 510.k₁-k₂ together. The subject technology can be implemented with any number of power supply units 520.1-n, for example, one, two, three, four, five, or more than five power supply units 520.1-n. There may be any number of LED blocks 510.1-n and any number of power supply units 520.1-n. The number of LED blocks 510.1-n may be the same as or different from the number of power supply units 520.1-n. The processing hardware 530 can include one or more processors, a central processing unit (CPU), a graphics processing unit (GPU), or a control block. The processing hardware 530 is operative to execute computer instructions that are stored in a computer-readable medium, for example, the memory 540. The memory 540 stores data or instructions. The memory 540 may be one or more of a cache unit, a storage unit, an internal memory unit, or an external memory unit. As illustrated, the memory 540 may include a power management module 550.

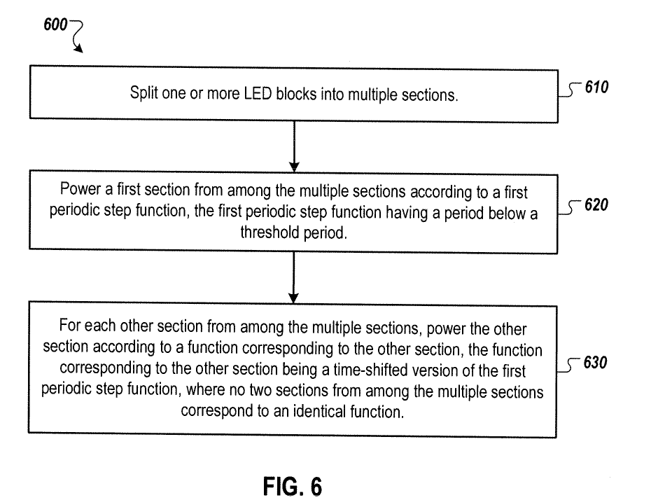

The power management module 550 is operative to control the supply of power, by the power supply units 520.1-n to the LED blocks 510.1-n. While the memory 540 and power management module 550 are depicted outside of the LED blocks 510.1-n, power supply units 520.1-n, and processing hardware 530, each or both may be locating in any location, e.g., any one or more or all of the LED blocks 510.1-n, power supply units 520.1-n, and processing hardware 530, or any other suitable location for some embodiments and applications. According to some aspects, the power management module 550 includes code for implementing the process described below in conjunction with FIG. 6.

FIG. 6 illustrates an exemplary process 600 for managing power supply load of light-emitting diode blocks.

The process 600 begins at step 610, where a computer (e.g., computing device 500) splits one or more LED blocks (e.g., one or more of the LED blocks 510.1-n) into multiple sections. The multiple sections can be any number of sections, for example, four sections. Each section includes one or more LED light sources.

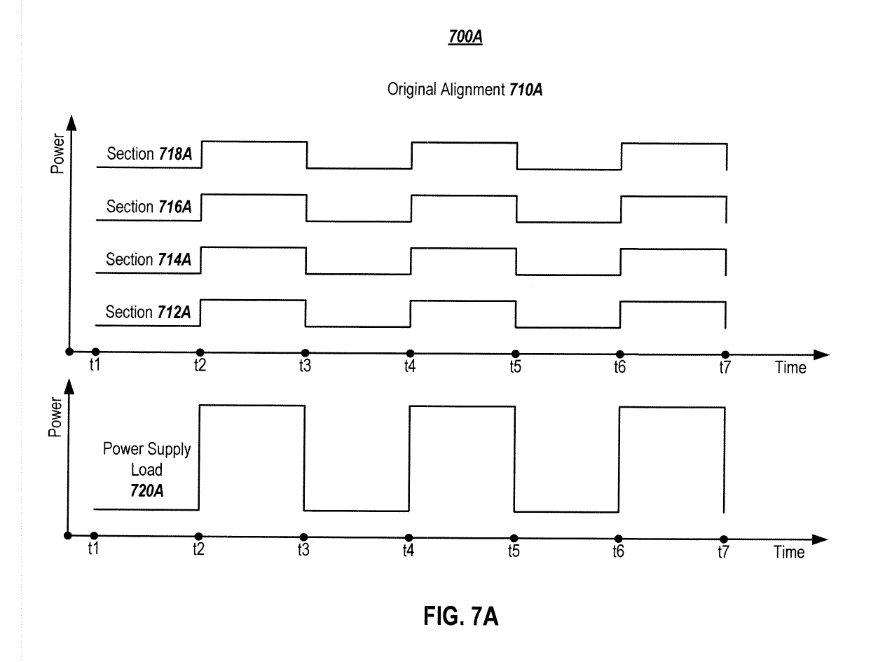

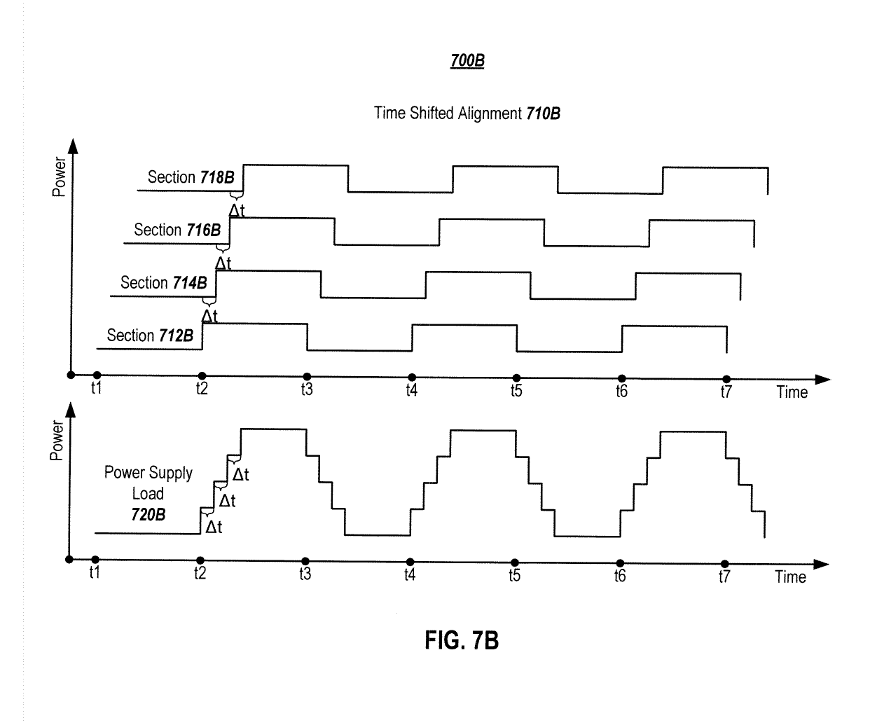

In step 620, the computer powers, using a power supply (e.g., one or more of the power supply units 520.1-n), a first section from among the multiple sections according to a first periodic step function. Examples of periodic step functions are described in conjunction with FIGS. 7A-7B, below.

In step 630, for each other section from among the multiple sections, the computer powers, using the power supply, the other section according to a function corresponding to the other section. The function corresponding to the other section is a time-shifted version of the first periodic step function. No two sections from among the multiple sections correspond to an identical function.

According to some aspects, at a first time, power is provided to each and every section from among the multiple sections. At a second time, power is provided to no section from among the multiple sections. A time difference between the first time and the second time is half the period of the first periodic step function.

According to some aspects, the multiple sections are four sections—the first section, a second section, a third section, and a fourth section. The time shift between the first section and the second section is equal to the time shift between the second section and the third section. The time shift between the first section and the second section is equal to the time shift between the third section and the fourth section. After step 630, the process 600 ends.

FIGS. 7A-7B illustrate exemplary graphs 700A and 700B of power supply load with respect to time.

FIG. 7A illustrates graphs 700A of an original alignment 710A of power supply with respect to time of four sections 712A, 714A, 716A, and 718A into which one or more LED blocks can be divided, for example, via operation of the process 600 of FIG. 6. The power supply with respect to time for the first section 712A is a periodic step function. The period of the periodic step function is the time difference between times t1 and t3, as shown on the graph 710A. The power supply with respect to time for the other sections 714A, 716A, and 718A is identical to the power supply with respect to time for the first section 712A.

Graph 720A illustrates the total power supply load for the four sections 712A, 714A, 716A, and 718A. The total power supply in graph 720A is also a periodic step function, and corresponds to a sum of the individual periodic step functions of the four sections 712A, 714A, 716A, and 718A. As shown in graph 720A, at times t2, t3, t4, t5, t6, and t7, the power changes very steeply with respect to time. As a result of the large shifts of power with respect to time at times t2, t3, t4, t5, t6, and t7, the lifespan of the LED board including the sections may be reduced. Aspects of the subject technology described in conjunction with FIG. 7B attempt to solve this problem.

FIG. 7B illustrates graphs 700B of a time shifted alignment 710B (relative to the original alignment 710A of graphs 700A of FIG. 7A) of power supply with respect to time of four sections 712B, 714B, 716B, and 718B into which one or more LED blocks can be divided, for example, via operation of the process 600 of FIG. 6. The four sections 712B, 714B. 716B, and 718B correspond to the four sections 712A, 714A, 716A, and 718A of FIG. 7A. The power supply with respect to time for the first section 712B is a periodic step function (identical to that for 712A). The period of the periodic step function is the time difference between times t1 and t3, as shown on the graph 710B. The power supply with respect to time for the other sections 714B, 716B, and 718B is a time shifted version of the power supply with respect to time for the first section 712B. In some aspects, the time shift between section 712B and 714B is equal to the time shift between section 714B and 716B, and equal to the time shift between section 716B and 718B.

As used herein, the phrase “time shifted” encompasses its plain and ordinary meaning including but not limited to, a function g(t), where t refers to time, is a time shifted version of a function ƒ(t) if there exists a value of Δt such that g(t)=ƒ(t+Δt). At may be positive or negative.

As shown in FIG. 7B, the power for section 714B is time shifted with respect to the power for section 712B by Δt. The power for section 716E is time shifted with respect to the power for section 714B by Δt. The power for section 718B is time shifted with respect to the power for section 716B by Δt. According to some aspects, the time difference Δt is be shorter than a time for which an image needs to be presented to be perceived by a human (e.g., 0.04 seconds).

Graph 720B illustrates the total power supply load for the four sections 712B, 714B, 716B, and 718B. The total power supply in graph 720B is a periodic function having a period equal to the period of the power supply graph for section 712B (the time difference between t3 and t1). However, graph 720E is characterized by smaller shifts in power supply with respect to time rather than the large shifts of graph 720A of FIG. 7A. As a result of the smaller shifts in power supply, the lifespan of the LED board including the sections may be increased relative to the aspects of the subject technology described in conjunction with FIG. 7A, saving repair or replacement costs for an owner of the LED board.

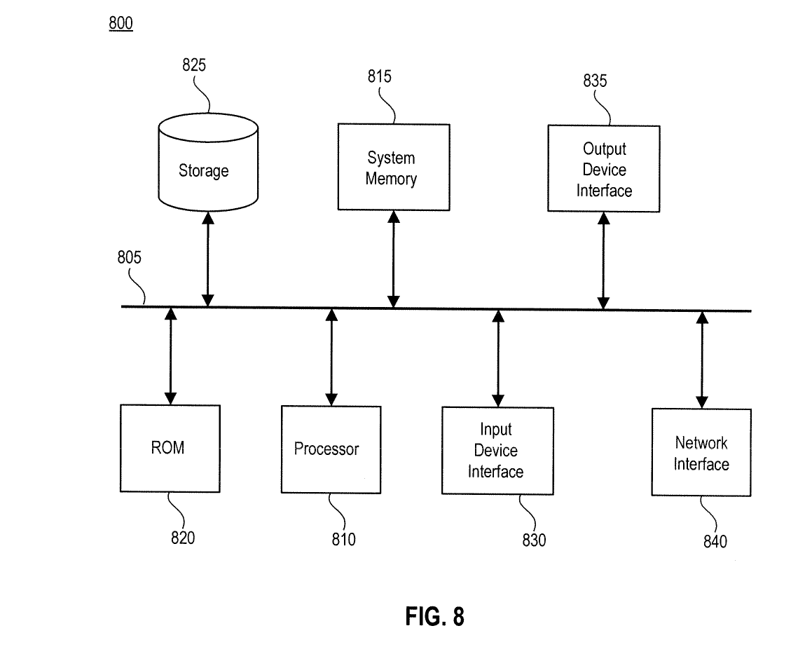

FIG. 8 conceptually illustrates an electronic system 800 with which some implementations of the subject technology are implemented. For example, one or more of the matrix controller 110 or the computing device 500 may be implemented using the arrangement of the electronic system 800. The electronic system 800 can be a computer (e.g., a mobile phone, PDA), or any other sort of electronic device. Such an electronic system includes various types of computer readable media and interfaces for various other types of computer readable media. Electronic system 800 includes a bus 805, processing unit(s) 810, a system memory 815, a read-only memory 820, a permanent storage device 825, an input device interface 830, an output device interface 835, and a network interface 840.

The bus 805 collectively represents all system, peripheral, and chipset buses that communicatively connect the numerous internal devices of the electronic system 800. For instance, the bus 805 communicatively connects the processing unit(s) 810 with the read-only memory 820, the system memory 815, and the permanent storage device 825.

From these various memory units, the processing unit(s) 810 retrieves instructions to execute and data to process in order to execute the processes of the subject technology. The processing unit(s) can be a single processor or a multi-core processor in different implementations.

The read-only-memory (ROM) 820 stores static data and instructions that are needed by the processing unit(s) 810 and other modules of the electronic system. The permanent storage device 825, on the other hand, is a read-and-write memory device. This device is a non-volatile memory unit that stores instructions and data even when the electronic system 800 is off. Some implementations of the subject technology use a mass-storage device (for example a magnetic or optical disk and its corresponding disk drive) as the permanent storage device 825.

Other implementations use a removable storage device (for example a floppy disk, flash drive, and its corresponding disk drive) as the permanent storage device 825. Like the permanent storage device 825, the system memory 815 is a read-and-write memory device. However, unlike storage device 825, the system memory 815 is a volatile read-and-write memory, such a random access memory. The system memory 815 stores some of the instructions and data that the processor needs at runtime. In some implementations, the processes of the subject technology are stored in the system memory 815, the permanent storage device 825, or the read-only memory 820. For example, the various memory units include instructions for video board control or powering a video board in accordance with some implementations. From these various memory units, the processing unit(s) 810 retrieves instructions to execute and data to process in order to execute the processes of some implementations.

The bus 805 also connects to the input and output device interfaces 830 and 835. The input device interface 830 enables the user to communicate information and select commands to the electronic system. Input devices used with input device interface 830 include, for example, alphanumeric keyboards and pointing devices (also called “cursor control devices”). Output device interfaces 835 enables, for example, the display of images generated by the electronic system 800. Output devices used with output device interface 835 include, for example, printers and display devices, for example cathode ray tubes (CRT) or liquid crystal displays (LCD). Some implementations include devices for example a touch screen that functions as both input and output devices.

Finally, as shown in FIG. 8, bus 805 also couples electronic system 800 to a network (not shown) through a network interface 840. In this manner, the electronic system 800 can be a part of a network of computers (for example a local area network (“LAN”), a wide area network (“WAN”), or an Intranet, or a network of networks, for example the Internet. Any or all components of electronic system 800 can be used in conjunction with the subject technology.

The above-described features and applications can be implemented as software processes that are specified as a set of instructions recorded on a computer readable storage medium (also referred to as computer readable medium). When these instructions are executed by one, or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM. DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

1. A computer-implemented method for providing power to one or more LED blocks, the method comprising:
splitting the one or more LED blocks into plural sections;
powering a first section from among the plural sections according to a first periodic step function;
for each other section from among the plural sections, powering the other section according to a function corresponding to the other section, the function corresponding to the other section being a time-shifted version of the first periodic step function, wherein no two sections from among the plural sections correspond to an identical function.

2. The method of claim 1, wherein, at a first time, power is provided to each section from among the plural sections, wherein, at a second time, power is provided to no section from among the plural sections and wherein a time difference between the first time and the second time is half a period of the first periodic step function.

3. The method of claim 1, wherein the plural sections comprise four sections.

4. The method of claim 3, wherein a time shift between the first section of the four sections and a second section of the four sections is equal to a time shift between the second section and a third section of the four sections and to a time shift between the third section and a fourth section of the four sections.

5. The method of claim 4, wherein the time shift between the first section of the four sections and a second section of the four sections is shorter than a time for which an image needs to be presented to be perceived by a human.

6. The method of claim 1, wherein each of the one or more LED blocks has a corresponding power source.

7. The method of claim 1, wherein at least two of the one or more LED blocks share a single power source.

8. A non-transitory computer-readable medium for providing power to one or more LED blocks, the computer-readable medium comprising instructions for:
splitting the one or more LED blocks into plural sections;
powering a first section from among the plural sections according to a first periodic step function;
for each other section from among the plural sections, powering the other section according to a function corresponding to the other section, the function corresponding to the other section being a time-shifted version of the first periodic step function, wherein no two sections from among the plural sections correspond to an identical function.

9. The computer-readable medium of claim 8, wherein, at a first time, power is provided to each section from among the plural sections, wherein, at a second time, power is provided to no section from among the plural sections and wherein a time difference between the first time and the second time is half a period of the first periodic step function.

10. The computer-readable medium of claim 8, wherein the plural sections comprise four sections.

11. The computer-readable medium of claim 10, wherein a time shift between the first section of the four sections and a second section of the four sections is equal to a time shift between the second section and a third section of the four sections and to a time shift between the third section and a fourth section of the four sections.

12. The computer-readable medium of claim 11, wherein the time shift between the first section of the four sections and a second section of the four sections is shorter than a time for which an image needs to be presented to be perceived by a human.

13. The computer-readable medium of claim 8, wherein each of the one or more LED blocks has a corresponding power source.

14. The computer-readable medium of claim 8, wherein at least two of the one or more LED blocks share a single power source.

15. A system for providing power, the system comprising:
one or more LED blocks;
a power supply;
processing hardware operative to implement instructions stored in a computer-readable medium, and
the computer-readable medium comprising the instructions for:
splitting the one or more LED blocks into plural sections;
powering, using the power supply, a first section from among the plural sections according to a first periodic step function;
for each other section from among the plural sections, powering, using the power supply, the other section according to a function corresponding to the other section, the function corresponding to the other section being a time-shifted version of the first periodic step function, wherein no two sections from among the plural sections correspond to an identical function.

16. The system of claim 15, wherein, at a first time, power is provided to each section from among the plural sections, wherein, at a second time, power is provided to no section from among the plural sections and wherein a time difference between the first time and the second time is half a period of the first periodic step function.

17. The system of claim 15, wherein the plural sections comprise four sections.

18. The system of claim 17, wherein a time shift between the first section of the four sections and a second section of the four sections is equal to a time shift between the second section and a third section of the four sections and to a time shift between the third section and a fourth section of the four sections.

19. The system of claim 18, wherein the time shift between the first section of the four sections and a second section of the four sections is shorter than a time for which an image needs to be presented to be perceived by a human.

20. The system of claim 15, wherein each of the one or more LED blocks has a corresponding power source.

21. The system of claim 15, wherein at least two of the one or more LED blocks share a single power source.
